(19) United States
(12) Patent Application Publication
(10) Pub. No.: US 2014/0326038 A1
(43) Pub. Date: Nov. 6, 2014

(54) In Situ Calibration of a Level Measuring Device

(71) Applicant: Eric Fauveau, Baton Rouge, LA (US)

(72) Inventor: Eric Fauveau, Baton Rouge, LA (US)

(21) Appl. No.: 14/266,390

(22) Filed: Apr. 30, 2014

Related U.S. Application Data
(60) Provisional application No. 61/818,078, filed on May 1, 2013.

(51) Int. Cl. G01F 25/00

(52) U.S. Cl. CPC G01F 25/0061
USPC 73/1.73

(57) ABSTRACT

A calibration system for a level meter comprising a tank having a sidewall and a bottom defining a tank interior, and a stilling well coupled to said tank, said stilling well having a sidewall, proximal and distal ends and a stilling well interior, and the distal end in fluid communication with the tank interior near the tank bottom, said proximal end of said stilling well being sealingly coupled to said level meter, said stilling well having a calibration fluid path allowing fluids to flow out of said stilling well interior; said stilling well having a vent opening that is sealingly closable near said proximal end; and a source of pressurized gas connectable to said stilling well interior, said stilling well having a measurement configuration where said vent opening is opened allowing said proximal end to vent gases in said stilling well interior, and a calibration configuration, where said pressurized air source is connected to said stilling well and flowing into said stilling well interior, where said pressurized gas may exit said stilling well interior only at said calibration flow path.

This application claims the priority benefit of U.S. Provisional application No. 61/818,078 filed on May 1, 2013, the contents of which are hereby incorporated by reference.

### BACKGROUND OF THE INVENTION

Level measuring devices are used to measure the level of fluids in a container, such as a closed tank or an open tank, such as a pool. Generally, a level measuring device (level meter or level detector) detects a response that is related to the fluid level in the tank. The response may be due to be an active action of the level meter, such as generating a signal that is launched or transmitted into the tank interior or along a sensor probe positioned in the tank, and receiving a return signal from a fluid interface or a fluid contact (“time of flight” or time domain reflectometry (TDR) measurement device), such as in guided wave radar level (GWR, for instance ABB K-Tek model MT5000) or microwave detectors, non-contact radar or microwave level detectors, magnetostrictive level detectors (for instance, ABB K-Kek model AT100, or AT200), ultrasonic level detectors (such as ABB K-Tek model KMICRO or KMICROLP), and laser level detectors (such as ABB K-Tek model LM200). The active action of the level meter may be that of applying a radio frequency signal to a capacitance or admittance probe and measuring the capacitance or admittance of the tank/probe or guide/fluid system, which is related to the fluid level in the tanks (such as ABB K-Tek model A02). Alternatively, in a closed tank, a level meter may be passive, such as in a differential pressure level detector, which determines fluid levels in a tank based on pressure readings at two different locations in the tank system. Many level meters detect the fluid contact or fluid interface in the tank, as measured from a reference point. For instance, in a GWR application, the reference point may be the launch point or launch plate for the microwave signal, or the fiducial pulse generated by the GWR hardware. In these level detector systems, the level device measures the height above the fluid contact, or the ullage, and the software or firmware in the level meter instrumentation or controls then subtracts the known tank height from the ullage to arrive at the fluid height in the tank. In other systems such as capacitance level systems, or displacer level meters (a displacer body is suspended on a measuring spring and is immersed in the liquid and is subjected to an upthrust based on Archimedes' principle, and the change in the weight of the body corresponds to a certain change in the length of the spring and is therefore an indication of the liquid level) where the measured quality is directly related to the height of fluid in the tank. For purposes of this application, whether the device measures the ullage (indirect fluid level in tank) or measures the fluid level in the tank directly (such as a capacitance level detector), both indirect and direct measurements are considered as measuring the fluid level in the tank (or in the stilling well), and the level measurement may be expressed in distance, time of flight, capacitance, or any other measurement directly taken by the level meter, or later calculated based on measurements of the level meter.

If a flexible sensor probe is used, it is preferred that the probe terminate within the tank (distant from the instrumentation) with a heavy weight, to keep the probe stable in the process conditions present in the tank. For purposes of this application, all of the above level detectors, passive or active, direct or indirect, including those using time domain reflectometry (TDR), GWR, magnetostrictive, ultrasonic, laser, capacitance or other recited principles, are considered as “level meters.” A level meter may include a sensor and certain electronics that will be sealingly coupled to the tank or stilling well (e.g the equipment is mounted to seal, that is, the interior volume of the tank or stilling well to which the level meter is attached in order to contain and maintain the pressured environment expected in the tank or stilling well), and in some embodiments, the level meter will have remotely located electronics (signal generators and signal processors, microprocessors, storage medium) that communicate with the tank mounted equipment via cables. The level meter electronics and equipment are well known in the art.

With any level meter, the instrument must be calibrated for accuracy. For instance, there may be time delays in the instrumentation, or variation in signal propagation speed, or variation in pressure that are temperature dependent, that should be accounted for in order to accurately measure fluid level in the tank. These level detector systems, once installed, are difficult to calibrate in the field. Calibration generally involves removing the instrument and bench testing the instrument. However, de-installing and bench testing is time consuming, expensive, and can have inherent errors, as the calibration does not replicate field conditions or the installation conditions, which can effect level detection. Another calibration involves manually changing the level in the tank or vessel by removing or adding fluid to the container. This can be a quite involved and costly procedure. A technique is needed to allow in place or in-situ calibration of level measuring instruments.

### DESCRIPTION OF THE DRAWINGS

FIG. 1 is a flow chart showing one embodiment of the steps of a calibration sequence and depicting changing of the fluid contact in the well during a calibration sequence.

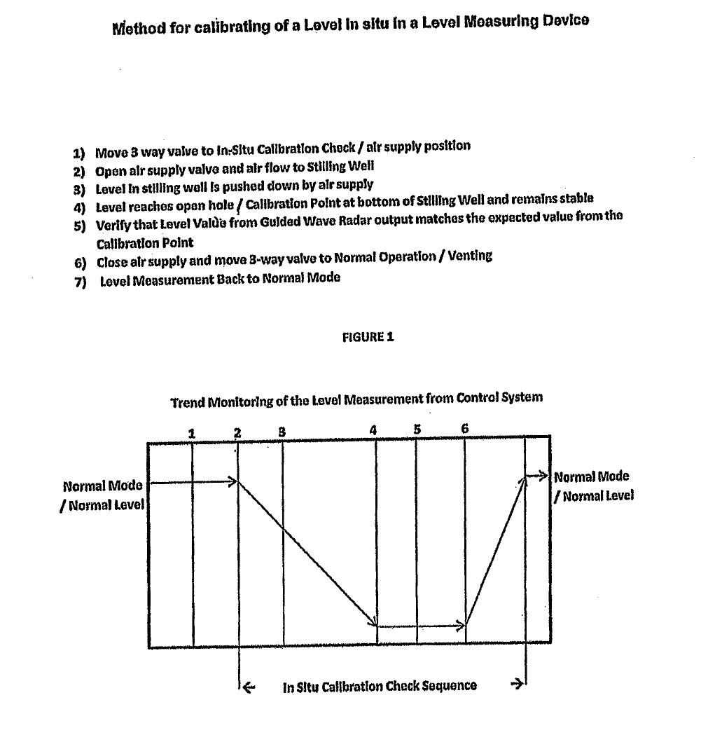

FIG. 2 depicts an open tank environment with some of the equipment to practice one embodiment of the invention.

FIG. 3 depicts an open tank environment containing a stilling well, with some of the equipment to practice one embodiment of the invention.

FIG. 4 depicts a closed tank environment containing a remotely located bridle well, with some of the equipment to practice one embodiment of the invention

FIG. 5 depicts a closed tank environment containing a remotely located bridle well, where the bridle well itself operates as the calibration stilling well in one embodiment of the invention

### SUMMARY OF THE INVENTION

One embodiment of the invention includes a stilling well with a level meter sealingly mounted to the proximal end or top of the stilling well. The stilling well has an opening near the bottom or distal end of the stilling well for fluid communication with the exterior of the stilling well (the distal opening). The top end of the stilling well has an opening (the proximal opening), generally controlled by a valve, where in one position, the valve connects a source of pressurized gas to the stilling well interior, and in a second position, the source of pressurized gas is no longer in fluid communication with the stilling well interior, but the interior of the stilling well near the top end is in fluid communication with the exterior of the stilling well, such as a tank interior volume. The stilling well may have a second opening (the calibration opening) between the vent opening and the distal opening. One embodiment of the invention includes a method of calibration in situ (e.g. without removal of the level meter from the stilling well) where gas is flowed from a source of pressurized gas (such as by a pump, or differential pressure flow) into the stilling well interior through the proximal opening.

### DETAILED DESCRIPTION OF THE INVENTION

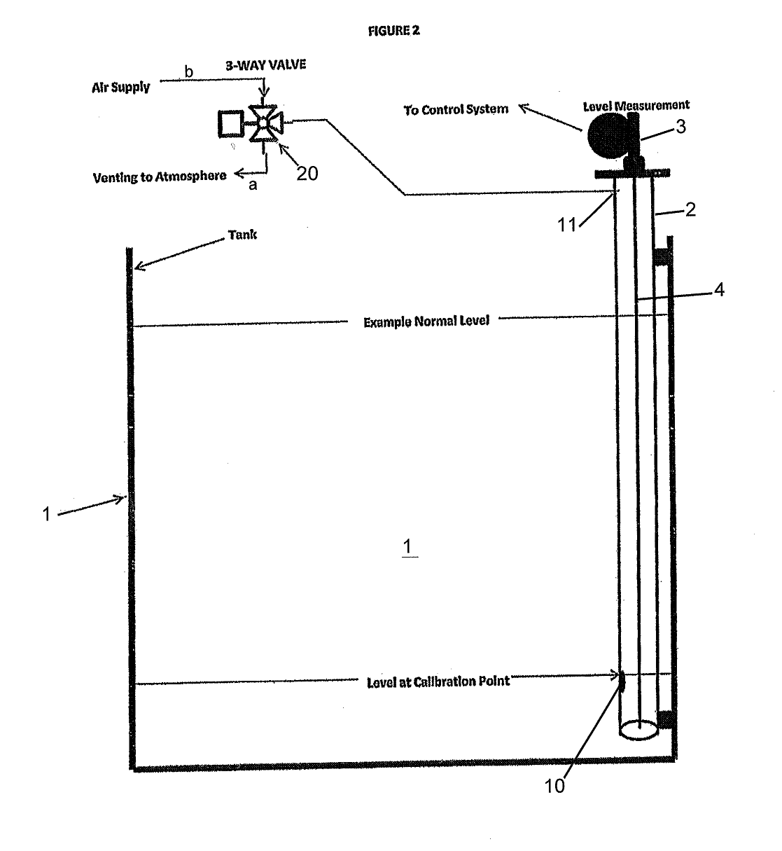

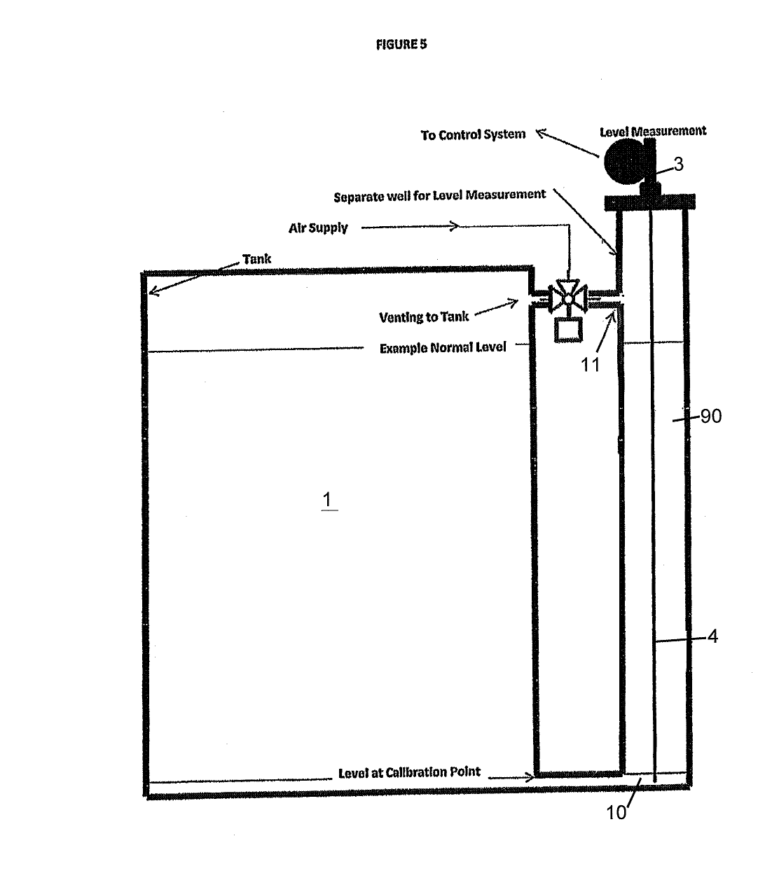

The invention includes both an apparatus, and a method. One embodiment of the apparatus is shown in FIG. 2. Shown is a stilling well 2. The stilling well (sometimes referred to as a “well” herein) is generally a tubular cylinder that is mounted or either extends into the tank or vessel (such as by having the stilling well extending from an instrument flange near the top of the tank and extending into the tank interior for an enclosed or closed tank) or supported near the tank top for an open tank or pool or body of water environment, or is a separate cylindrical structure that is in fluid communication with the tank or pool or body of water (such as shown in FIG. 5, sometimes referred to as a bridle or bridle well). The well generally has openings in the sidewall or the bottom of the well (the proximal opening) to allow fluids to enter the well bore or well interior. The bottom of the well may be open or closed, or partially opened. The well used in one embodiment of the present invention will have a calibration fluid path 10 (generally an opening in the stilling well). The calibration fluid path or opening 10 may be located in the sidewall of the well cylinder, such as near bottom termination end of the well (e.g. the end closest to the tank bottom and generally opposite the instrumentation). Any openings in the well above the calibration opening should be sealably closeable during calibration, other than the opening to the air or gas source, later described. Preferably, there are no openings above the calibration opening (e.g. between the well top and the calibration opening), other than a vent opening 11 or proximal opening 11, such as shown in FIG. 2. Preferably, the calibration opening is below the normally anticipated low level fluid contact in the tank (e.g. the calibration opening is generally covered with fluid). The stilling well should be sealably closable above the fluid calibration path, except for the proximal opening (e.g. capable of being placed in a sealing configuration).

Attached to or in fluid communication with the stilling well is a gas input or source of pressurized gas. For instance, in the embodiment shown in FIG. 2, an open tank 1 has a stilling well 2 supported within in the tank. Sealingly attached to the top of the stilling well is a portion 3 of the level meter instrumentation (other portions of the instrumentation, such as a signal generator and signal receiver, may be remotely located). In the embodiment shown in FIG. 2, the level meter uses a probe or transmission line 4 that extends inside the well and into the tank (such as for GWR or magnetostrictive level meter). As shown, the well 2 sidewall has two openings above the distal opening, a lower calibration opening 10, and an upper vent opening 11 (the proximal opening) located above the calibration opening. The vent opening 11 is connected to a valve body with a valve 20. As shown, the valve 20 allows the vent opening 11, in a first valve position A, to communicate with the atmosphere or the environment exterior of the stilling well interior (preferable, communication with the atmosphere interior to the tank in the case of a closed tank, or to the ambient atmosphere in the case of an open tank), to keep the pressure in the stilling well interior substantially constant to, for instance, the tank interior. In a second valve position B, the vent opening 11 is connected to a gas supply. The vent opening 11 may be positioned on the top of the guide well (as opposed to the sidewall, not shown) or the vent opening 11 can be two openings, a first closable vent to the atmosphere opening 11A or tank interior, and second closable vent 11B to an air or gas supply. The valve body may accommodate many different valve types, including check valves, ball valves, gate valves, etc. As shown, the calibration fluid path or opening is positioned between the proximal opening and the distal opening. Also as shown, the vent path maybe one opening, and the source of gas connected to the stilling well interior through a separate gas path or opening. This is not preferred, as two separate valves are needed in this configuration, and for mechanized remote control, two separate remotely operable valves.

To undertake an in situ calibration, the valve body 20 is placed in position B where venting to the atmosphere or tank interior is closed and the gas supply line is placed in fluid communication with the interior of the well (the calibration configuration, were the interior is not vented). Gas flow is initiated from the gas supply, and gas (such as air or a gas inert with respect to the fluid in the tank) flowing into the well interior bore begins to pressurize the well interior volume above the ambient pressure in the well column or well bore. Because the well is sealingly closed from the top of the well to the calibration opening (the instrumentation that enters the well top is sealingly connected to the well), the fluid contact in the well, initially in a first position, generally the level reflecting tank fluid levels, will begin to drop (slightly raising the fluid level in the remaining volume exterior the well, but if the cross-sectional area of the stilling well is small, this fluid rise can be minimized). Alternatively, an overflow reservoir (such as another well) may be fluidly connected to the well below the calibration opening, to receive fluid in the well due to the fluid outflow caused by pressurization of the well (not shown).

As pressurized gas flow continues into the well interior, the stilling well fluid level will continue to drop, until the fluid/gas contact reaches the calibration opening (the second position). At this point, any additional input of gas into the well bore will bleed off through the calibration opening, and the position of the fluid contact in the well interior (the stilling well fluid level) will cease dropping and stabilize. The level detector can be utilized to determine when the fluid contact has stabilized, and the measured stable contact position is the “measured calibration level.” Once stable, gas flow may be interrupted (closing the valve body so the interior of the well is isolated, e.g. the vent opening is closed). Once the position of the fluid contact is stable, the fluid contact is at a known point—the fluid level of the top of the calibration opening. The fluid contact position in the well interior, measured by the level meter, can be compared to the known stored position of the calibration opening (the “predetermined calibration level”). If the measured calibration level is within a predetermined or set threshold of the predetermined calibration level, the level system measured level values are accurate within the threshold levels, and no modifications to the fluid levels as measured by the level meter, needs to be undertaken. If the measured calibration level is outside of the predetermined thresholds, measured levels are not accurate, and the difference between the measured calibration and predetermined calibration level can be used to alter or modify later level meter measurements. For instance, one calibration technique would be to store the difference and use the difference as an applied offset to future readings (using the difference as a “zero offset” adjustment, for instance to account for instrument drift). As an example, if the measured calibration fluid level is two inches above the known calibrated level, then the difference (measured calibration level-calibrated level) can be stored in the system (or replace a prior stored difference). Future measured contact level determinations would then have the stored difference added or subtracted from the measured level as appropriate (e.g. add two inches to the measured contact position; or subtract two inches from the determined tank fluid level). If the difference is used as a “span adjustment” (for instance to account for sensor misalignment), the difference between the measured and predetermined calibration level will be distributed over the length of the probe as a “per unit” adjustment, from signal start in the well to the signal end at the calibration point, and the per unit adjustment may be additionally extended below the calibration height.

Alternatively, the signal start or initiation point may be used as a second fixed reference point for two calibration points. For instance, in GWR, the signal start within the stilling well can be an engineered point, such as the launch plate, which generates a easily recognized return signal commonly referred to as a fiducial marker (see U.S. Pat. No. 5,609,059 or 6,867,729 both hereby incorporated by reference). Alternatively, an engineered point may be positioned along the probe at a known location to create an impedance difference. Using the fiducial return or the return from the engineered impedance point, and the signal from the calibration point, two reference calibrations points can be used to determine both a zero offset adjustment and a span adjustment. Note that in any method, the difference may be stored in the system as a height or distance measurement, or stored in units related to the height or distance (for instance, in a GWR level meter, the difference may be internally stored in counts, milliseconds or other suitable units for time of flight measurements), or if used as a span adjustment (as opposed to a zero adjustment), stored as a per unit increment or a slope. The system will store a value related to the difference. Instead of using the difference between measured level versus known calibrated level as an offset (e.g. a zero calibration), the difference may be used in other calibration techniques, for instance to modify other parameters used in the level calculation, such as to modify or account for changes in propagation speed.

If the measured calibration level is substantially different from the known calibration level (for instance absolute value of the difference is greater than a second predetermined threshold) such a discrepancy can be used as an indicator that the level meter has a hardware/software or installation fault or other fault that needs to be investigated.

If the level device is temperature sensitive, it may be desirable to precondition the air or gas stream for a desired temperature. The system as described may be incorporated into a computerized automatic calibration scheme, under guidance of the level meter control system, or initiated by a command from the control system. For this automated process, any valves used in the system preferably are capable of operation from the control system. The control system may store the differences (or a value related to the difference, such as a calculated span adjustment) from each calibration sequence for future reference and tracking of instrument performance over time.

The system may also be able to track the volume of gas inserted into the well from the gas source (such as using a flow meter and known pressure of the gas source, or calculated pressure). The volume of gas inserted can be used as a check in the calibration sequence. For instance, the volume of gas needed to drop the level in the stilling well bore from the presently determined contact level (before the calibration sequence is initiated) to the known calibration can be calculated based on the cross section of the stilling well, tank environment pressures, gas source pressure, etc.). If the volume of gas inserted substantially varies from this calculated volumes, before level stabilization is achieved, it may be an indication of level system malfunction, and that the calibration sequence should be stopped to allow investigation of the cause of the variation. In other embodiments, the source of gas may be gas in the tank interior in a closed tank system, where a pump pumps the tank interior gases (thereby pressuring the gases) from the tank interior, through the valve, into the stilling well. In other embodiments for a closed tank, gases may be vented from the stilling well, through a valve, into the atmosphere, but this is not usually preferred.

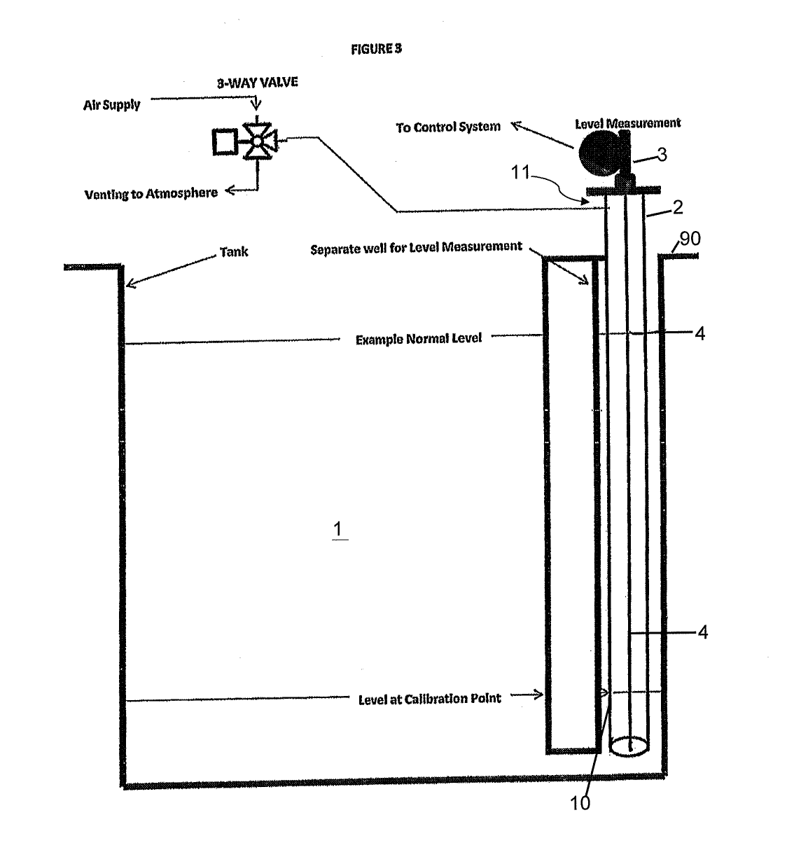

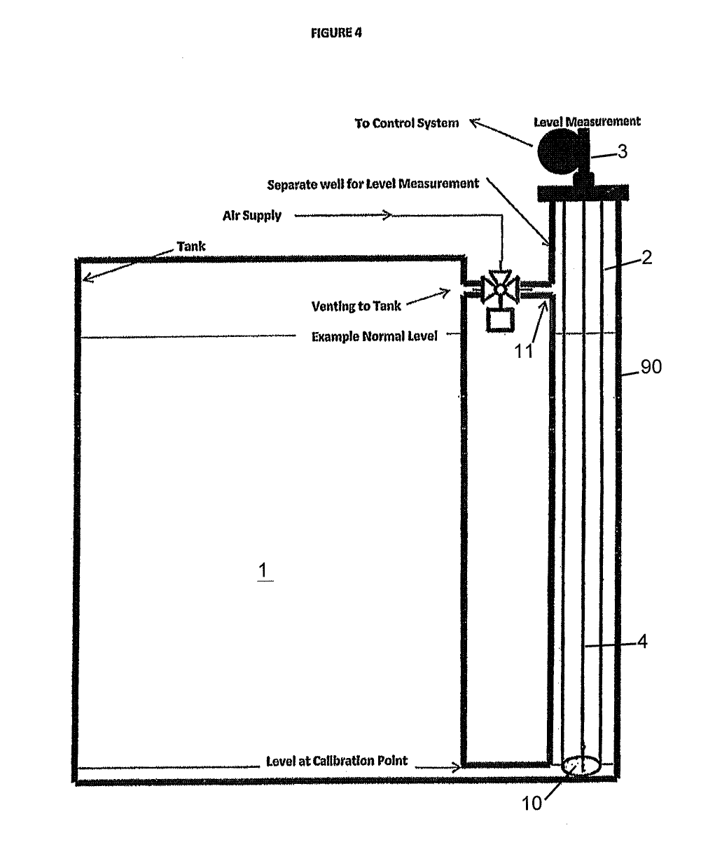

Other embodiments of the system are shown in FIGS. 3-5. FIGS. 3 and 4 show embodiments of possible configuration of the invention when located in an existing separate tank well 90. In FIG. 3, an open tank has positioned therein a separate well 90 (often referred to as a bridle or instrument standpipe) has the stilling well 2 positioned in the interior of the existing well 90. In FIG. 4, a similar configuration is shown in a closed tank embodiment. FIG. 5 shows an embodiment where the existing bridle well 90 is used as the stilling well in a closed tank environment. In this configuration, the valve may have to be inserted in the existing vent line between the tank and well 90. A similar configuration can be used in an open tank (not shown). In FIGS. 3 and 4, the calibration opening is a separate opening in the sidewall of the stilling well, and preferably is large enough (such as a horizontally orientated slit of about an inch across) to allow the passage of air therethrough to escape more rapidly than the highest feed rate of air or gas into the well. In FIG. 5, the bridle well 90 itself operates as the stilling well.

The gas feed rate into the stilling well interior may be modified as the calibration sequence proceeds, for instance, the feed rate may be slowed as the calculated injected volume approaches the volume expected to be needed to reach the calibration level, to avoid injecting excess gas into the tank interior. After the calibration sequence is complete, the valve may have an additional position to bleed off the added air, for instance, the valve may be fluidly connected to a gas reservoir to bleed off the added gas for later discharge. Alternatively the value may be returned to its normal vent state, the preferred embodiment in an open tank configuration. Separate openings in the well may be used for the vent and gas source. As depicted, the calibration well opening 10 is located near the bottom of the stilling well. This is generally preferred to allow for calibration through the range of possible tank levels. However, calibration opening may be located in the stilling well in other locations, with the limitation that calibration may not take place at fluid levels below the calibration opening (unless the stilling well has multiple closable calibration openings, in which event, for instance, one might open the calibration opening located below the measured levels (such as using a valve), and closing all other calibration openings located above the measured level). The calibration well opening may also be the distal opening (e.g. there is only the proximal opening and distal opening) but this is not preferred, particularly if the distal opening corresponds to an open end of the stilling well. Additionally, while describes as being used in a tank or pool environment, the stilling well may be mounted in any “vessel” containing a liquid to be measured, including rivers or lakes.

1. A calibration system for a level meter comprising a level meter and a tank having a sidewall and a bottom defining a tank interior, and a stilling well coupled to said tank, said stilling well having a sidewall, proximal and distal ends and a stilling well interior, and the distal end in fluid communication with the tank interior, said tank interior having a having a fluid level therein, said proximal end of said stilling well being sealingly coupled to said level meter, said stilling well having a calibration fluid path allowing fluid flow between said stilling well interior and said tank interior, said stilling well having a vent opening that is sealingly closable near said proximal end by a valve; and a source of pressurized gas connectable to valve, said valve having a measurement configuration where said vent opening is open and allowing gases in said proximal end of said stilling well to communicate with the exterior environment of said stilling well, said valve having a calibration configuration, where said pressurized gas source is in fluid communication with said stilling well interior through said valve.

2. A method of calibrating a level meter while said level meter is connected to a tank, the tank having a tank interior with a liquid stored therein, said liquid having a liquid level in said tank, where the tank includes a separate stilling well and the level meter is coupled to the stilling well, said stilling well being in fluid communication with the tank interior, the stilling well interior has liquid in the stilling well interior forming a stilling well liquid level, and the stilling well is connectable to a pressurized gas source; the method comprising the steps of (a) moving the stilling well liquid level from a first position to a second position in said stilling well, wherein in said first position, said stilling well liquid level is above a predetermined calibration level, and in said second position, said stilling well liquid level is substantially at said predetermined calibration level, where the transition from said first position to said second position is brought about by flowing pressurized gas into said stilling well; (b) measuring, with said level meter, the stilling well level in said second position; and (c) comparing said measured stilling well level from step (b) to a predetermined value.

3. The method of claim 2 wherein said level meter is selected from the list of: guided wave radar level meter, a microwave level meter, a non-contact radar or microwave level meter, a magnetostrictive level meter, an ultrasonic level meter, or a laser level meter.

4. The method of claim 2 wherein in said first position, said stilling well level is substantially equal to said tank liquid level.

5. The method of calibration according to claim 2 wherein said stilling well has a vent opening in fluid communication to said stilling well exterior and a valve connected to said vent opening, wherein in said first position said valve is positioned where said pressurized gas source is not connected to said stilling well interior but said stilling well may vent gases in said stilling well to said stilling well exterior, and wherein in said second position, said valve is positioned where said pressurized gas source is connected to said stilling well interior and said stilling well does not vent gases in said stilling well interior to said stilling well exterior through said valve.

6. The method of claim 5 wherein said valve is a three way valve.

7. The method of claim 5 wherein said stilling well includes a calibration fluid path, said calibration fluid path allowing fluid communication between said stilling well interior and exterior, and said calibration fluid level is substantially at the level of said calibration fluid path in said stilling well.

8. The method of claim 2 further comprising the steps of storing a value related to said difference between said measured stilling well level to said predetermined value.

9. The method of claim 2 further comprising the steps of allowing said stilling well fluid level to transition from said second position to a stilling well liquid level substantially equal to the liquid level in said tank.

10. The method of claim 8 further comprising the steps of allowing said stilling well fluid level to transition from said second position to a stilling well liquid level substantially equal to the liquid level in said tank, measuring the liquid level in said stilling well after said transition with said level meter, and modifying said measured liquid level using said stored value.

11. The method of claim 10 wherein said stored value is used as a zero offset adjustment to modify said measured liquid level.

12. The method of claim 10 wherein said stored value is used as a span adjustment to modify said measured liquid level.

13. The method of claim 2 wherein when said stilling well level is at said second position, flowing additional gas into said stilling well interior does not substantiality change said stilling well liquid level.

14. A stilling well system comprising a level meter and a stilling well, said stilling well having a sidewall, proximal and distal ends, and a stilling well interior, and stilling well interior in fluid communication exterior to the stilling well via a calibration fluid opening, said level meter sealingly coupled to said stilling well near said stilling well proximal end, said stilling well having a vent opening that is sealingly closable with a valve, said calibration fluid opening positioned between said vent opening and said proximal end, and a source of pressurized gas connectable to valve, said stilling well system having a calibration configuration wherein gas flows from said pressurized gas source into said stilling well interior through said valve, and gases do not exit said vent opening; said stilling well system having a measurement configuration, whereby gases exist said stilling well interior though said vent opening.

15. The stilling well system of claim 14 wherein said level meter is one of a guided wave radar level meter, a microwave level meter, a non-contact radar or microwave level meter, a magnetostrictive level meter, an ultrasonic level meter, or a laser level meter.
